(19) United States
(12) Patent Application Publication
(10) Pub. No.: US 2026/0148309 A1
(43) Pub. Date: May 28, 2026

(54) SYSTEMS AND METHODS FOR CUSTOMER CALLBACK SCHEDULER

(71) Applicant: State Farm Mutual Automobile Insurance Company, Bloomington, IL (US)

(72) Inventors: Billy Simonovich, Sugar Hill, GA (US); Hannah Brock, Atlanta, GA (US); Qichang Bao, Duluth, GA (US); Jared Musil, Roswell, GA (US); Matthew Hogden, Oregon City, OR (US); Yohan Santos, Miami, FL (US); Brian Dockins, Rowlett, TX (US); Manuela Holt, Heyworth, IL (US); Ana Williams, Cumming, GA (US); Grant Bacon, Decatur, GA (US)

(73) Assignee: State Farm Mutual Automobile Insurance Company, Bloomington, IL (US)

(21) Appl. No.: 18/963,173

(22) Filed: Nov. 27, 2024

(51) Int. Cl. G06Q 40/08; G06Q 10/0631

(52) U.S. Cl. CPC G06Q 40/08; G06Q 10/06311

(57) ABSTRACT

A system for scheduling a callback includes instructions that, when executed by a processor, cause the processor to: generate a URL to schedule the callback, provide the URL with the embedded security token to a user device, receive information relating to a service request associated with the callback to be scheduled, receive a selection of the URL from the user device, determine a queue from which to retrieve a plurality of timeslots based on the information relating to the service request, retrieve the plurality of timeslots from the determined queue, the plurality of timeslots associated with an agent associated with the determined queue, transmit, to the user device, the plurality of timeslots, receive, from the user device, a selection of a timeslot, and schedule the callback at the selected timeslot.

### FIELD OF THE INVENTION

The present disclosure generally relates to callback systems. More particularly, the present systems and methods relate to scheduling a customer callback with an appropriate agent.

### BACKGROUND

Individuals and organizations may use various methods to manage and resolve service requests. For instance, an insurer may manage and resolve open insurance claims.

However, different types of claims may pose challenges for agents to address and resolve. Conventional techniques may also have certain ineffectiveness, inefficiencies, encumbrances, and/or other drawbacks as well.

### SUMMARY

In one aspect, a system for scheduling a callback may include one or more non-transitory computer readable media storing instructions thereon that. When executed by one or more processors, the instructions may cause the one or more processors to generate a URL to schedule the callback, the URL unique to the user and the callback and allowing the user to schedule the callback independent of a registration of the user with the system, generating the URL including: generating a security token to permit the user to schedule the callback, and embedding the security token within the URL, provide the URL with the embedded security token to a user device, receive information relating to a service request associated with the callback to be scheduled, receive a selection of the URL from the user device, determine, from a plurality of queues, a queue from which to retrieve a plurality of timeslots to schedule the callback based on the information relating to the service request, request by determining a characteristic of the service request using the information, and determining the first queue from among the plurality of queues by determining the first queue is associated with agents designated to respond to the service request based on the characteristic of the service request, retrieve the plurality of timeslots from the determined queue, the plurality of timeslots associated with an agent of the plurality of agents associated with the determined queue, transmit, to the user device, the plurality of timeslots, receive, from the user device, a selection of a timeslot, and schedule the callback at the selected timeslot. The computer system may include additional, less, or alternate functionality and/or operations, including that discussed elsewhere herein.

In some implementations, the instructions further cause the one or more processors to present, to the user via the user device, based on the received plurality of timeslots and an availability of the user, a subset of the plurality of timeslots. In some implementations, the information relating to the service request includes a location of at least one of the user or an event associated with the service request. In some embodiments, generating the security token includes extracting one or more parameters from the URL, the one or more parameters associated with an identifier of the user associated with the URL. In certain implementations, the security token is generated using the one or more extracted parameters. In some embodiments, generating the URL further includes hashing the URL to hide the one or more parameters and the security token within the URL. In some implementations, the instructions further cause the one or more processors to access, using public key cryptology, a data field, the data field including the identifier of the user associated with the URL.

In certain implementations, the instructions further cause the one or more processors to transmit a phone number of the user to the agent to initiate the callback at the selected timeslot. In various embodiments, the instructions further cause the one or more processors to validate an authentication of the user using the security token embedded in the URL. In some embodiments, validating an authentication of the user using the security token is performed prior to providing the user with options for timeslots, and retrieving the plurality of timeslots from the determined queue is performed responsive to authenticating the user.

In various implementations, each queue of the plurality of queues is associated with a different jurisdiction, wherein each jurisdiction has associated requirements for the plurality of agents associated with the queue. In some embodiments, each queue of the plurality of queues is associated with one or more different capabilities, wherein each agent of the plurality of agents associated with each queue is designated as possessing the capabilities. In certain implementations, each queue of the plurality of queues is associated with at least one of: a level of experience or a designated role.

In another aspect, a method for generating a custom URL for a user to schedule a callback includes: extracting one or more parameters from the URL, the one or more parameters associated with an identifier of the user associated with the URL, generating, using the extracted parameters, a security token to permit the user to schedule the callback embedding the security token within the URL hashing the URL to hide the one or more parameters and the security token within the URL, and providing, by the one or more processors, the URL with the embedded security token to a user device.

In certain implementations, the URL is unique to the user and the callback to be scheduled. In various embodiments, the URL allows the user to schedule the callback independent of a registration of the user with the system. In some implementations, the method includes accessing, using public key cryptology, a data field, the data field including the identifier of the user associated with the URL.

In at least one aspect, one or more non-transitory computer readable storage media store instructions for scheduling a callback thereon that, when executed by one or more processors, cause the one or more processors to perform operations including: receiving, from a user device, a selection of a URL to schedule the callback, determining, from a plurality of queues, a queue from which to retrieve a plurality of timeslots to schedule the callback based on the information relating to the claim, request by determining a characteristic of the service request using the information, and determining the first queue from among the plurality of queues by determining the first queue is associated with agents designated to respond to the service request based on the characteristic of the service request, retrieving the plurality of timeslots from the determined queue, the plurality of timeslots associated with an agent of the plurality of agents associated with the determined queue, and transmitting, to the user device, the plurality of timeslots.

In certain embodiments, each queue of the plurality of queues is associated with a different jurisdiction, wherein each jurisdiction has associated requirements for the plurality of agents associated with the queue. In some embodiments, each queue of the plurality of queues is associated with one or more different capabilities, wherein each agent of the plurality of agents associated with each queue is designated as possessing the capabilities. In some implementations, each queue of the plurality of queues is associated with at least one of: a level of experience or a designated role.

Advantages will become more apparent to those skilled in the art from the following description of embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary callback scheduler system, according to some embodiments.

FIG. 2 is a flow diagram of an exemplary computer-implemented or computer-based process of modeling unstructured data items, according to some embodiments.

FIG. 3 is a flow diagram of an exemplary computer-implemented or computer-based process of modeling unstructured data items, according to some embodiments.

FIG. 4A is a flow diagram of encryption and decryption processes, according to some embodiments.

FIG. 4B is a flow diagram of a get process, according to some embodiments.

FIG. 4C is a flow diagram of a post process, according to some embodiments.

FIG. 4D is a flow diagram of a token generation process, according to some embodiments.

FIG. 5 is an exemplary computer-implemented or computer-based process of scheduling a callback, according to some embodiments.

FIG. 6 is an exemplary user interface for scheduling a callback, according to some embodiments.

FIG. 7 is an exemplary user interface for scheduling a callback, according to some embodiments.

FIG. 8 is an exemplary user interface for confirming a scheduled callback, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to a computer system for scheduling callbacks. For instance, a user or customer may have an open claim or service request associated with an insurance provider and may require a follow up call (e.g., a callback) with an agent to resolve the service request.

The systems and methods discussed herein provide an automated method of scheduling a callback with an agent associated with the provider. Specifically, the systems and methods described herein include generating a user-specific URL that links to a user interface for the user to schedule a callback. The user-specific URL may include encrypted parameters associated with the user and a generated security token that allows the user to access various components of the system to schedule the callback. Providing a user-specific URL with encrypted data may allow users that are not associated with the provider to schedule a callback. For example, a user may be involved with a service request that is not a customer of the provider. In typical systems, in order to schedule a callback, the user may be required to have an account associated with the provider (i.e., be a customer of the provider). As such, in order to schedule a callback, the user may have to input user credentials to log into their account and schedule the callback. This may limit the number of people associated with a particular service request that can actually view the service request and resolve the service request, thus making the process of resolving the service request more difficult.

Further, the systems and methods described herein include selecting a specific queue from which to assign an agent to handle the customer callback. Agents may be assigned to queues based on certain jurisdictions (e.g., locations) of the user, the service request, or the agent, based on certain capabilities of the agents (e.g., based on licensing), or based on experience (e.g., a number of years of experience or a type of role). This may streamline the process of connecting an agent with a user because the user is initially connected with an agent determined to be capable of addressing and resolving the service request. Thus, the systems and methods described herein eliminate the need for a user to contact multiple agents to arrive at one that is experienced in the type of request the user has.

### Overview

Referring to the Figures, computer systems and computer-implemented methods for scheduling a callback may be provided. For example, the computer system may be configured to determine or receive an indication that a user is to receive a callback. For instance, a user may or may not be a customer of a provider (e.g., an insurance agency). The user may have previously spoken to or attempted to speak to an agent associated with the provider and the system may have determined (e.g., based on an indication from the agent speaking with the user, based on an indication of a missed call from the user, etc.) that a callback to the user should be enabled. In various embodiments, the user may request a callback from the provider to discuss an action relating to a protection policy (e.g., an insurance policy) and/or service request (e.g., an insurance claim) associated with the user.

Upon receipt of the indication that the user is to schedule a callback, the system may generate a uniform resource locator (URL) to send to the user to permit the user to schedule the callback. Advantageously, the URL may be unique to the user, thereby allowing the user to proceed with scheduling a callback without having to input personal information (e.g., a phone number) because the system has populated a user interface for scheduling the callback with user information. Further, the URL may be encrypted to permit a user that is not associated with the provider (e.g., is not a customer or policyholder of the insurance company) to schedule a callback. Advantageously, the systems and methods described herein can be performed for a broad range of users and may not be limited to registered users. Additionally, encryption of the URL may enhance security of the system and prevent unauthorized or unverified users from accessing sensitive or personal information.

In certain embodiments, responsive to a selection of the URL by the user, the system may determine an appropriate agent to speak with the user during the scheduled callback. Different service requests may have different characteristics or associated events that may be able to be handled only by specific types of agents. Agents associated with the provider may also be associated with a specific queue or grouping of agents according to one or more parameters. For example, each agent may be associated with a queue based on an experience level, a type of license, a type of role, a location, or other capability. The agent may be assigned to the user based on a type of assistance needed (e.g., as indicated by the service request).

Assigning agents to different queues based on their capabilities and subsequently selecting an agent from a specific queue according to the service request and a capability of the agents in the queue may improve computing efficiency of the system. Agents are predesignated or assigned to a particular queue before a request to schedule a callback is received. Thus, when the request is received, the system can determine an appropriate queue and select an agent from the queue, meaning the agent is selected from a smaller pool of agents relative to a total number of agents associated with the provider.

This may reduce computing time and power because the system only parses or searches through a small number of agents assigned to the determined queue. For example, rather than first searching through every agent associated with the provider to find every agent that is capable of handling the service request, and further searching through the capable agents to select an appropriate agent, the system can identify a queue and search through a single queue. By categorizing agents according to capability, the system can efficiently retrieve an appropriate agent.

Advantageously, this may streamline the conversation between the user and the agent and more effectively provide assistance to the user. For example, assigning an agent to contact the user that has been determined to be able to assist the user prior to the agent conversing with the user may prevent the user from being transferred to and from multiple agents on a phone call while the agent(s) determine who is best suited to assist the user. This may increase user satisfaction and reduce call times, thereby allowing agents to address and resolve an increased number of cases and streamline customer service processes.

### Example Callback System

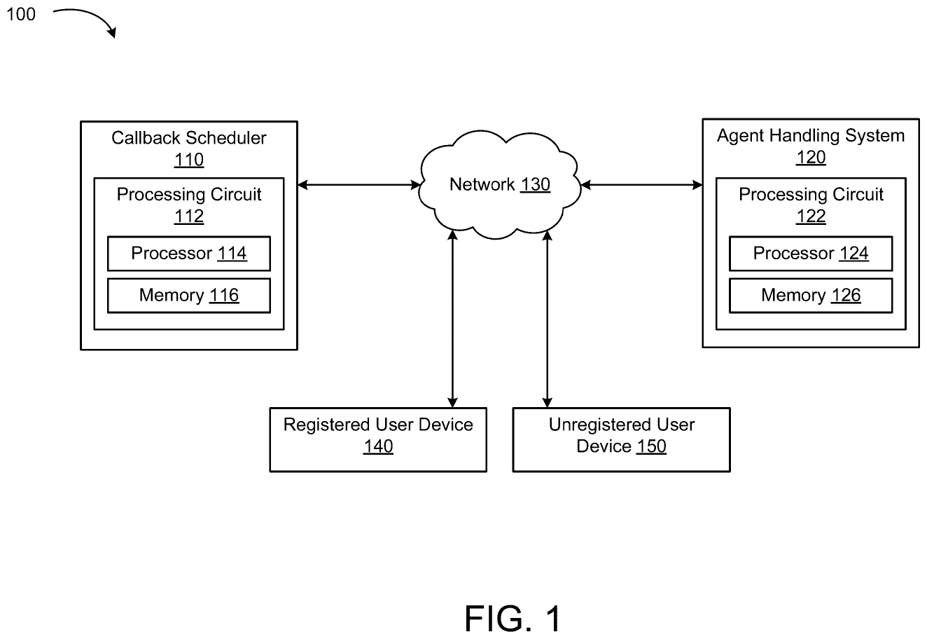

Referring to FIG. 1, a block diagram of an exemplary callback scheduling system, shown as callback scheduling system 100, is shown, according to some embodiments. The callback scheduling system 100 may include a callback scheduling system, shown as callback scheduler 110 having a processing circuit 112, processor 114, and a memory 116.

The callback scheduling system 100 may also include an agent handling system 120 having a processing circuit 122, a processor 124, and a memory 126. The callback scheduling system 100 may also include a plurality of user devices, shown as registered user device 140 and unregistered user device 150.

The components of the callback scheduling system 100 may be connected, or in wired or wireless communication, via a network 130. It should be noted that the number and type of components shown is merely illustrative and, in various implementations, implementations of the callback scheduling system 100 may have additional, fewer, and/or different components than those illustrated in FIG. 1 including those mentioned elsewhere herein.

The components of the callback scheduling system 100 may be connected, or in communication, via a network 130. Network 130 may include computer networks such as the Internet, local, wide, metro or other area networks, intranets, satellite networks, other computer networks such as voice or data mobile phone communication networks, combinations thereof, or any other type of electronic communications network. Network 130 may include or constitute a display network. In some implementations, network 130 facilitates secure communication between components of callback scheduling system 100.

As a non-limiting example, network 130 may implement transport layer security (TLS), secure sockets layer (SSL), hypertext transfer protocol secure (HTTPS), and/or any other secure communication protocol. It should be noted that the number and type of components shown are merely illustrative, and in various embodiments, implementations of the callback scheduling system 100 may have additional, fewer, and/or different components than those illustrated in FIG. 1.

The network 130 may facilitate communication between various nodes, such as the callback scheduler 110, the agent handling system 120, the registered user device 140, and the unregistered user device 150. In some implementations, data flows through the network 130 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 130 layered over an OSI layer-3 network protocol such as Internet Protocol (IP), e.g., IPv4 or IPv6.

The network 130 may be composed of various network devices (nodes) that are communicatively linked to form one or more data communication paths between participating devices. Each networked device includes at least one network interface for receiving and/or transmitting data, typically as one or more data packets. An illustrative network 130 is the Internet; however, other networks may be used. The network 130 may be an autonomous system (AS), i.e., a network that is operated under a consistent unified routing policy (or at least appears to be from outside the AS network) and is generally managed by a single administrative entity (e.g., a system operator, administrator, or administrative group).

Generally, the callback scheduler 110, the agent handling system 120, the registered user device 140, and the unregistered user device 150 may include one or more logic devices, which may be one or more computing devices equipped with one or more processing circuits (e.g., processing circuit(s) 112 and/or processing circuit(s) 122) that run instructions stored in a memory device (e.g., memory 116 and/or memory 126) to perform various operations. The processing circuit may be made up of various components such as a microprocessor, an ASIC, or an FPGA, and the memory device may be any type of storage or transmission device capable of providing program instructions.

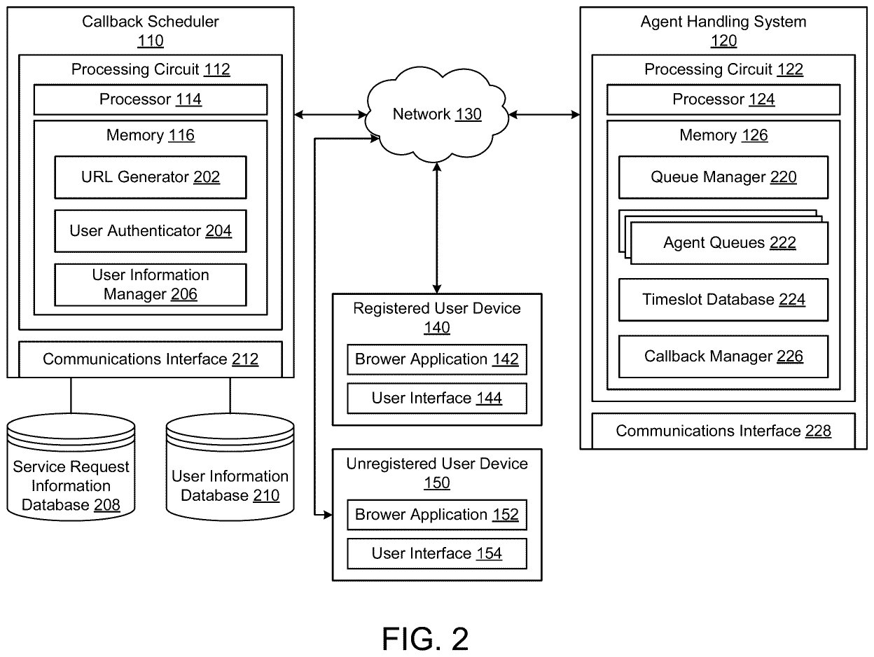

The instructions may include code from various programming languages commonly used in the industry, such as high-level programming languages, web development languages, and system programming languages. The callback scheduler 110, the agent handling system 120, the registered user device 140, and the unregistered user device 150 may also include one or more databases for storing data, such as service request information database 208 and user information database 210 (shown and described with respect to FIG. 2), that receive and provide data to other systems and devices on the network 130.

Each system or device in callback scheduling system 100 may include one or more processors, memories, network interfaces (sometimes referred to herein as a “network circuit”) and user interfaces. The memory (e.g., memory 116 and/or memory 126) may store programming logic that, when executed by the processor (e.g., processor(s) 114 and/or processor(s) 124) controls the operation of the corresponding computing system or device. The memory may also store data in databases. For instance, memory 116 may store programming logic that when executed by processor 114 within processing circuit 112, causes the callback scheduler 110 to generate a URL.

The network interfaces may allow the computing systems and devices to communicate wirelessly or otherwise. The various components of devices in callback scheduling system 100 may be implemented via hardware (e.g., circuitry), software (e.g., executable code), or any combination thereof. Devices, systems, and components in FIG. 1 may be added, deleted, integrated, separated, and/or rearranged in various embodiments of the disclosure.

As will be discussed in greater detail below, the callback scheduler 110 may be configured to generate a URL to send to a user. The URL may be associated with a website or other application (e.g., a mobile application, a browser application, etc.) where the user can schedule a date and time to receive a callback from an agent. The callback scheduler 110 may further be configured to encrypt the generated URL to permit users not associated with the provider (e.g., users that are not customers of the insurance agency) to schedule a callback. For example, a user may not be a customer of the provider and may have gotten into a motor accident with another that is a customer of the provider. The user that is not a customer may call the provider after the accident to resolve any policy-related implications of the accident. Upon receiving the URL to schedule the callback, the user may not have to enter user credentials associated with the provider to be able to schedule the callback.

The callback scheduler 110 may also be configured to authenticate a user attempting to schedule the callback. In various embodiments, authenticating the user may permit the callback scheduler 110 to permit unregistered users to access the scheduler without logging into an account associated with the provider, as described above.

The callback scheduler 110 may also be configured to retrieve, from a plurality of databases, information relating to the user (e.g., a phone number, an email address, etc.) and/or the service request (e.g., claim) that that user is scheduling the callback for. The callback scheduler 110 will be described in greater detail with respect to FIG. 2.

The agent handling system 120 may be configured to determine an agent available to accept the callback request of the user. For example, based on information of the user and the service request that the user is scheduling the callback for, a specific type of agent may be assigned that has experience, expertise, and/or other capabilities that allow the agent to successfully handle the service request.

Upon determining an appropriate agent to handle the service request, the agent handling system 120 may determine one or more timeslots when the agent is available to call the user. The agent handling system 120 may transmit the timeslots to the user. Responsive to the user selecting a timeslot, the agent handling system 120 may automatically initiate a call between the assigned agent and the user at the specified time.

It should be understood that, in various implementations, fewer, additional, or different components may be utilized. For example, in some implementations, the callback scheduler 110 and the agent handling system 120 may be integrated within a single system (e.g., a single discrete computing system, a single distributed or cloud computing system, etc.). All such modifications are contemplated within the scope of the present disclosure.

Referring now to FIG. 2, the callback scheduling system 100 is shown in greater detail, according to some embodiments. As shown in FIG. 2, the callback scheduler 110 includes, in the memory 116, a URL generator 202, a user authenticator 204, a user information manager 206, and a communications interface 212. The agent handling system 120 includes, in the memory 126, a queue manager 220, a plurality of agent queues 222, a timeslot database 224, a callback manager 226, and a communications interface 228. The callback scheduling system 100 may further include a service request information database 208 and a user information database 210. As shown in FIG. 2, the registered user device 140 and the unregistered user device 150 each include a browser application (shown as browser applications 142 and 152, respectively) and a user interface (shown as user interfaces 144 and 154, respectively).

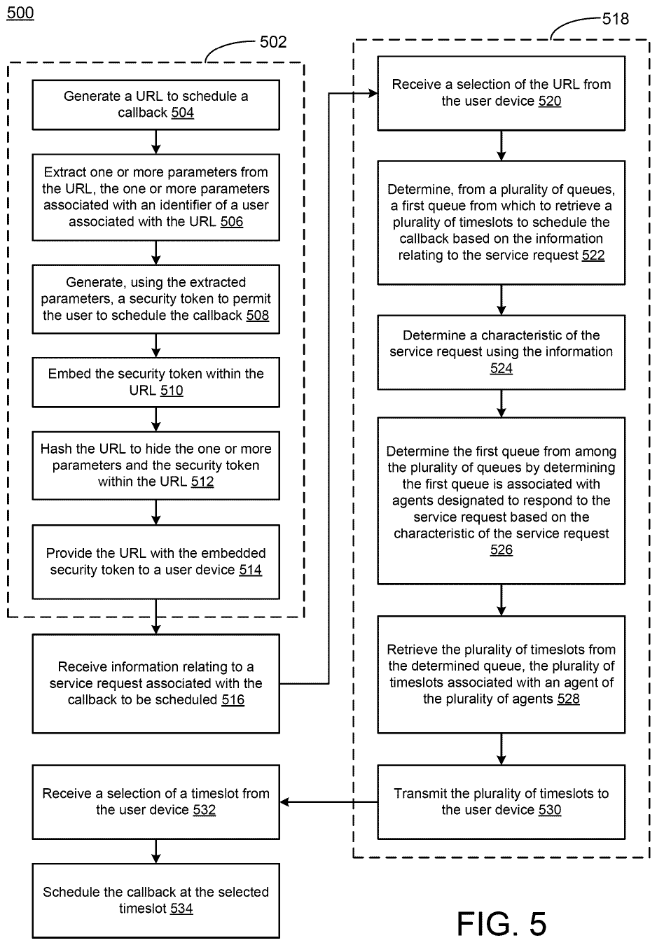

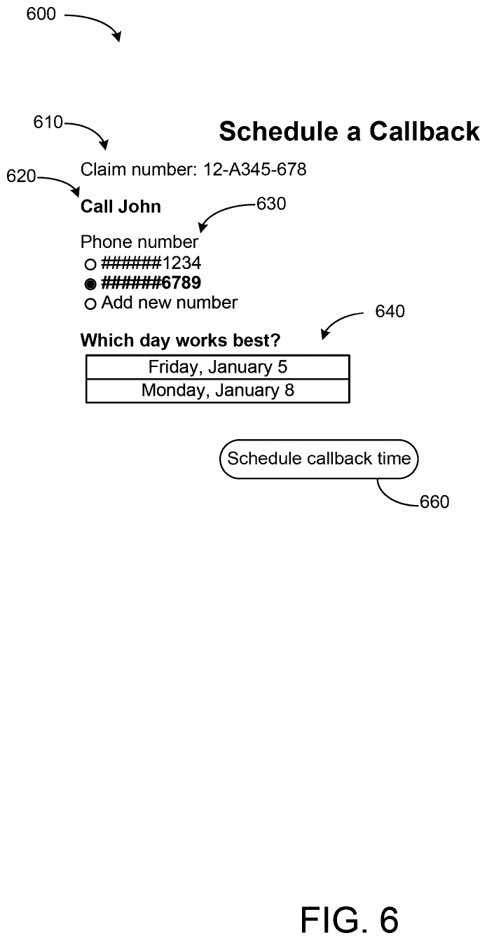

As stated above with respect to FIG. 1, the callback scheduling system 100 may receive an indication that a callback is to be scheduled with a user. For example, the user may have called, attempted to call, or received a call from the provider (e.g., an insurance company). Based on the outcome of the call or call attempt, the callback scheduling system 100 may determine or receive an indication that a callback is to be scheduled with the user. Responsive to this determination, the callback scheduler 110 may generate a URL to send to the user. The user may be able to select the URL, and the callback scheduling system 100 may generate a user interface to display to the user. The user interface may allow the user to schedule the callback with an agent of the provider. Examples of the user interfaces are described in greater detail with respect to FIGS. 5 and 6.

As used herein, a “call” may refer to any communication method. For example, a call may be a telephonic call, a video call, a communication between the user and the agent over an Internet-based medium (e.g., Microsoft Teams®, Zoom®, etc.), or any other type of communication between the user and the agent. The call may be initiated and/or received using a telephone, a mobile phone, a computer, etc.

The URL generator 202 may generate the URL to be transmitted and displayed to the user. In various embodiments, the URL generator 202 may transmit the URL to the registered user device 140 and/or the unregistered user device 150 via a text message. In other implementations, the URL may be transmitted to the user device 140 or 150 via an email, a notification associated with a mobile application of the provider, or other manner. The URL may be unique to the user and/or the callback to be scheduled by the user. In some embodiments, the URL may be sent internally. That is, a first agent associated with the provider may send the URL to a second agent associated with the provider such that an agent is able to schedule the callback (e.g., on behalf of a user).

As will be described in greater detail herein, the user-specific URL may allow the user to schedule the callback independent of whether the user is associated with the provider. For example, the user scheduling a callback may or may not be a customer of the provider and may or may not have a user account and/or user credentials associated with the provider. The custom URL generated by the URL generator 202 may allow an unregistered user to access the URL and schedule a callback without inputting user credentials that would be associated with a user account.

The URL generator 202 may generate the custom URL upon determining or receiving the indication that a callback is to be scheduled by a user. In various implementations, the URL generator 202 may generate a URL including one or more parameters within the URL. The one or more parameters may be associated with an identifier of the user for whom the URL will be delivered. For example, the callback scheduler 110 may receive information including, for example, a name of the user to receive the URL, a phone number, email address, or other type of contact information to send the URL to, and/or other identifying information of the user. The parameters within the URL may correspond to one or more of these identifying information such that the URL is specific to the user. In various embodiments, the user information may be stored in the user information database 210. In some implementations, the user information manager 206 retrieves the user information from the user information database 210 and transmits the information to the URL generator 202. The parameters may be encrypted to protect user privacy.

The URL generator 202 may extract the parameters from the URL to generate a security token. The security token may allow the callback scheduler 110 to access one or more elements or features of the callback scheduling system 100 (e.g., the agent handling system 120, etc.) to facilitate a registered or unregistered user scheduling a callback. For example, the generated security token may allow the callback scheduler 110 to access one or more APIs of the callback scheduling system 100 that facilitate the scheduling of a customer callback. Upon generating the security token, the URL generator 202 may embed the security token within the custom URL.

The URL generator 202 may hash the generated URL to hide the one or more parameters within the URL. In some implementations, the URL generator 202 may hash the URL to further enhance the security of the information. For example, hashing the URL may prevent an unauthorized user from accessing sensitive personal information of the intended user that is located within the URL. The custom generated URL that is transmitted to the user may include the embedded security token and the hashed-out parameters. In various embodiments, the hidden parameters may be accessed using a cryptological methods, such as public key cryptology. Public key cryptology may be used to access a data field that includes the user information found in the one or more parameters. Upon generation of the hashed-out URL, the URL generator 202 transmits the URL to the registered user device 140 and/or the unregistered user device 150.

The generated URL may be received by the registered user device 140 and/or the unregistered user device 150 via, for example, a text message. The URL generator 202 may transmit the URL to the appropriate user device based on the user information found in the one or more parameters. For example, during an initial call, the user may speak to an agent of the provider using a specific phone number. In some implementations, the URL is delivered to a phone number stored in the user information database 210 that is associated with the name of the user. The callback scheduling system 100 may store the user's name and phone number and retrieve the information for use in determining where to send the URL that leads to the user interface where the user can schedule the callback. The URL may be hyperlinked and selectable by the user via a user interface 144 or 154 of the user device 140 or 150, respectively.

In various implementations, the URL generator 202 may configure the URL such that the URL is active for a predefined time period. In some implementations, the URL may become active upon delivery of the notification (e.g., text message) containing the hyperlinked URL. The predefined period of time may be, for example one day after delivery of the notification, 48 hours of delivery of the notification, etc.). In various embodiments, the period of activity of the URL may be dependent upon a type of information relating to one or more of the user or the claim. For example, a type or severity of the service request the user is calling about, an urgency of the service request to be addressed, a complexity of the service request, and or an urgency of an agent to speak with the user may cause the activation period of the URL to be increased or decreased from a standard time period. For example, a standard or baseline activation period may be 24 hours. If a service request is time-sensitive, the activation period of the URL may be increased, such as to 30 hours, to provide the user with additional time to schedule the callback before the URL expires and the user has to contact the provider to receive a new URL.

Upon receipt of the URL by the user device 140 and/or 150, the user may select the URL. Upon selection of the link, the user devices 140 or 150 may display a new user interface 144 or 154, respectively. The user interface 144 or 154 may be associated with or be part of the browser application 142 or 152, respectively. For example, the user interface may be a user interface on the browser application with which the user can interact to schedule the callback.

The callback scheduler 110 may receive selection or an indication of a selection of the URL from the user device. Upon receipt of the selection or indication of the selection, the user authenticator 204 may validate an authentication and/or identity of the user associated with the generated URL. The user authenticator 204 may validate the authentication of the user using the security token embedded in the URL. That is, the user authenticator 204 may decrypt the encrypted URL to permit the user to schedule the callback. In various embodiments, the user authenticator 204 decrypts the URL using public key cryptology. Responsive to authentication of the user, the user authenticator 204 may permit the user to proceed with scheduling the callback.

Upon user authentication, the user interfaces 144 or 154 may display a user interface in which the user can view details relating to scheduling the callback. For example, the user may view a service request identifier and one or more contact methods associated with the user. This information may be received from the database 208 and 210. In some embodiments, the service request identifier may be predetermined based on the user information used to generate the URL. For example, based on an initial call or interaction between the user and an agent, the callback scheduling system 100 may already have a service request identifier associated with the user and the callback to be scheduled.

In some embodiments, the user interface may allow the user to input details related to scheduling the callback. For example, the user may input a service request identifier. The callback scheduler 110 may receive the user input of the service request identifier. The callback scheduler 110 may also receive an input or indication from the user of a method of contacting the user. For example, the callback scheduler 110 may receive a phone number, email address, etc. at which the user can be reached for the callback. The callback scheduler 110 may also receive an indication of a preferred date of the user for the callback to occur. The preferred dates displayed on the user interface may depend upon, for example, an urgency of the service request and/or an availability of agents to handle callbacks at a current time. Upon selecting a preferred date, the user can submit the information (e.g., the service request number, the preferred method of contact, and the preferred date) to be received by the callback scheduler 110. The user interface for scheduling the callback will be described in greater detail with respect to FIGS. 6-8.

As stated above, in certain implementations, the callback scheduler 110 may receive information relating to a service request (e.g., a claim) associated with the callback to be scheduled. For example, based on the user information from the user information database 210, the user information manager 206 may determine one or more service requests related to the user. In some examples, the user information manager 206 may determine the service request information based on the service request identifier input by the user when scheduling the callback. Specifically, the user information manager 206 may retrieve or receive, from the service request information database 208, information about one or more service requests associated with the user. For example, the service request information database 208 for a user may include a history of previously-filed service requests, resolved service requests, open service requests, etc. For each service request, the database 208 may include a service request identifier, a location at which an event related to the service request occurred, names and information of others involved in the service request, etc. The callback scheduler 110 may utilize the service request information and/or transmit the service request information to the agent handling system 120. In some embodiments, the user authenticator 204 may authenticate or validate the user prior to the user entering service request information and/or personal information to the user interface. In other embodiments, the user authenticator 204 may authenticate or validate the user after the user has entered the service request information and/or personal information but prior to the agent handling system 120 providing the user with timeslots from which to schedule the callback.

After the user authenticator 204 authenticates the user, the user authenticator 204 may indicate to the agent handling system 120 that the user has been authenticated. Upon receiving the indication that the user is authenticated, upon receipt of the preferred callback method and callback date from the user, and/or upon receipt of service request information and/or user information (e.g., from the databases 208 and 210), the queue manager 220 may determine a plurality of timeslots to provide to the user. The plurality of timeslots may be some or all dates and times at which the user is able to schedule a call with an agent associated with the provider. In some embodiments, the plurality of timeslots may be all timeslots available on the preferred date selected by the user. The plurality of timeslots may be provided to the user via a user interface responsive to determining one or more queues and one or more agents available to assist the user in a callback, as will be described below. In various embodiments, agents associated with the provider may be assigned to different agent queues 222 of agents from which an agent is selected to speak with the user during a scheduled callback. The agents may be assigned to different agent queues 222 based on various attributes of the agents.

In some embodiments, agents may be assigned to different agent queues 222 based on a location of the agent, a current location of the user scheduling the callback, and/or a location at which an event related to the service request occurred. Various jurisdictions (e.g., certain states, certain groups of states, certain regions of a country, etc.) may have specific regulations regarding where agents can be licensed and/or located to respond to certain user calls. The appropriate jurisdiction may be based on the service request identifier. For example, the service request identifier may include an indication of a state or region in which the user and/or the service request originated. This may inform which queue is appropriate to handle the callback.

For example, a user may be located in Florida and be scheduling a callback related to a service request for an event that occurred in Florida. The provider may impose regulations stating that only an agent licensed in and/or located in Florida is able to speak with users regarding service requests for events occurring in Florida and/or users located in Florida. In some embodiments, the provider may permit agents licensed in and/or located in Florida to handle service requests for events and users not located in Florida, but agents not licensed in and/or located in Florida may be unable to speak with such users. Further, in some examples, agents licensed in and/or located in certain places may be able to handle certain types of claims. For example, only agents licensed in and/or located in states in which hurricanes occur may be able to speak with users calling about service requests related to hurricanes.

In certain implementations, agents may be assigned to different agent queues 222 based on different capabilities. In some embodiments, agents may be assigned to different agent queues 222 based on types of service requests that they regularly address or have experience with. For example, agents may be assigned based on their capability to handle automotive-related service requests, home-related service requests, life-related service requests, etc. In one example, a user may schedule a callback for a service request related to an automotive protection policy. The agent speaking to the user may be assigned to agent queues 222 that includes only agents that are capable of handling automotive-related service requests.

In various embodiments, agents may be assigned to different agent queues 222 based on a level of experience of the agents and/or a designated role of the agent. For example, agents may be assigned to different agent queues 222 based on a number of years of service (e.g., an experience level). In some examples, an agent may be assigned to an agent queue 222 based on a type of role or job title (e.g., “senior agent”) corresponding to a number of years of service and/or specialized knowledge relating to the type of role. For example, if a user is scheduling a callback related to a complex service request, the agent speaking with the user may be assigned to a queue including agents that have above a certain number of years of experience (e.g., above five years).

In some embodiments, agents may be assigned randomly to a queue. For example, in some embodiments, service requests may not be associated with particular events or parameters that would necessitate a specific agent having a certain capability, experience level, location, etc. As such, agents may be assigned to a “general” queue that is equipped to handle any service request that is not associated with specific requirements. As such, when a user schedules a callback for a service request that is deemed to be able to be handled by a “general” agent not having particular requirements, the agent speaking with the user may be assigned to a general queue including agents having any sort of qualifications or background.

In various implementations, agents may be assigned to multiple agent queues 222 based on different types of attributes. For example, an agent licensed in and/or located in Texas with 15 years of experience in home-related service requests may be assigned to three queues based on their location, the location of their license, their amount of experience, and their type of experience, respectively. In some embodiments, agents may be assigned to a single agent queue 222 that assigns agents based on multiple criteria. For example, all agents licensed in and/or located in Texas with 15 years of experience in home-related service requests may be assigned to a single queue where all agents in the queue match the specific location, capability, and experience requirements.

The queue manager 220 may determine, from the plurality of agent queues 222, a queue from which to retrieve a plurality of timeslots to schedule the callback. The queue manager 220 may retrieve or receive from, for example, the callback scheduler 110, the service request information database 208, and/or the user information database 210, information to use to determine the appropriate queue. For example, the queue manager 220 may receive information from the service request information database 208 indicating that a service request is related to basement flooding. The queue manager 220 may also receive information from the user information database 210 indicating a name, location, and protection policy of the user that filed Atty. the service request. Based on the receipt of this data, the queue manager 220 may determine an appropriate queue from which an agent is selected.

For example, the queue manager 220 may determine a characteristic of the service request using the information relating to the service request. The queue manager 220 may determine a state in which an event relating to the service request occurred, and the characteristic (e.g., the location of the event) may indicate a queue or type of agent capable or designated to respond to the service request. For example, the characteristic may indicate that only agents licensed in and/or located in the state in which the event request occurred and are capable of responding to the service request.

Based on these determined characteristics, the queue manager 220 may determine a first queue from among the plurality of queues by determining the first queue is associated with agents designated to respond to the service request based on the characteristic of the service request. For example, the queue manager 220 may determine that a first queue is associated with agents licensed in and/or located in the state in which the event request occurred and are therefore capable of responding to the service request. The queue manager 220 may select the queue and/or an agent of the queue to address or respond to the service request and retrieve a plurality of timeslots associated with the selected agent.

In some implementations, the timeslots displayed to the user may be adjusted based on a time zone of the user and/or the agent. For example, a user may be located in California and the assigned agent may be located in New York. The timeslots displayed to the user may account for the difference in time zone, and, as such, the user interface may display time slots that are within business hours for both the user in California and the agent in New York.

Upon determining the appropriate queue, the queue manager 220 may select or determine an agent of the plurality of agents assigned to the determined queue to handle the callback with the user. In various embodiments, the agent may be randomly selected. For example, upon selecting the appropriate queue, any of the agents in the selected queue may be qualified to handle the user callback, and the queue manager 220 may randomly select an agent. In certain implementations, an agent may be randomly selected from a subset of agents of the agents assigned to the determined queue. For example, only a subset of agents may be capable of handling a callback (e.g., based on certain criteria associated with the service request, the user, and/or the queue attributes). In some implementations, the callback manager 226 may retrieve, upon selecting an agent to handle the callback, a plurality of timeslots from the timeslot database 224 during which the selected agent is available to speak with the user.

The callback manager 226 may transmit, to the user device 140 or the user device 150, the plurality of timeslots. The callback manager may also cause the plurality of timeslots to be displayed on the user interface 144 or the user interface 154. The callback manager may, upon the user selecting a timeslot via the user interface, receive an indication of the user's selected timeslot. In some implementations, the user may select multiple timeslots. For example, in some embodiments, the user may input multiple phone numbers and select a different preferred timeslot with each phone number. Based on the selected time, the callback manager 226 may schedule the callback at the selected timeslot. In embodiments where the user selects multiple timeslots, the callback manager 226 may select one of the selected timeslots during which the callback will occur. The callback manager 226 may select one of the multiple timeslots randomly or based on a type or urgency of the service requests, an available or preference of an agent, a preference of the user, etc. Upon selecting a timeslot, the callback manager may cause a second user interface to be displayed to the user via the user interface 144 or 154 that shows a confirmation of the callback at the scheduled time.

The callback manager 226 may present, to the user via the user device, based on the received plurality of timeslots and an availability of the user, a subset of the plurality of timeslots. Specifically, the callback manager 226 may determine or receive an indication of availability of the user. For example, the callback manager 226 may determine that the user is available for the callback during the hours of 7:00 AM to 12:00 PM on Monday and 3:00 PM to 7:00 PM on Tuesday. The callback manager 226 may compare the determined availability of the user with the plurality of timeslots associated with the selected queue and agent, and display, to the user via the user interface 144 or the user interface 154, only the timeslots that align with the available hours of the user. For example, the plurality of timeslots may indicate that the agent is available from 7:00 AM to 7:00 PM on both Monday and Tuesday. However, based on the availability of the user, the callback manager 226 may cause only timeslots from 7:00 AM to 12:00 PM on Monday and 3:00 PM to 7:00 PM on Tuesday to be displayed on the user interface.

Further, the callback manager 226 may transmit, to the selected agent, details relating to the scheduled callback. For example, the callback manager may transmit, to the agent, information relating to the service request (e.g., a type of service request, a description of the service request, previous actions or events relating to the service request, etc.) and/or information relating to the user (e.g., name, phone number, etc.). In some embodiments, the callback manager 226 may be configured to automatically initiate the callback at the scheduled time and date on the agent's behalf.

In some implementations, the agent handling system 120 may be able to adjust callbacks that have already been scheduled but have not yet occurred. For example, a user may have a scheduled callback but may call an agent prior to the scheduled call. The user may resolve their service request such that the scheduled callback is no longer needed. The agent handling system 120 may determine that the user's service request has been resolved and automatically cancel the scheduled callback. Further, in certain embodiments, a user may call or otherwise contact the provider and request that the scheduled callback time be changed. The agent handling system 120 may receive this request and automatically update the scheduled callback time. The user may be able to confirm the updated scheduled time.

In some embodiments, a plurality of agents able to handle the callback may be determined without selecting a single agent to handle the callback. For example, four agents may be determined, by the queue manager 220, to be capable of handling the callback. The callback manager 226 may then retrieve, from the timeslot database 224, a plurality of timeslots for all of the available agents to display to the user. Upon receiving, by the agent handling system 120, from either the user device 140, the user device 150, or the callback scheduler 110, an indication of a selected timeslot by the user, the agent that is to handle the callback is determined.

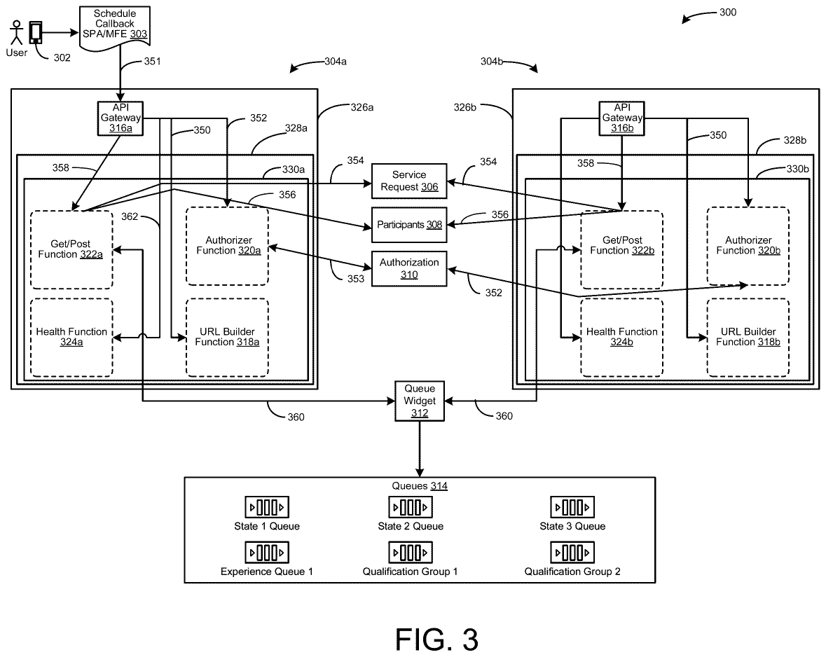

Referring now to FIG. 3, an example implementation of the callback scheduling system 100 is shown as system 300, according to some embodiments. The system 300 may include the same or similar elements to the callback scheduling system shown and described in FIGS. 1 and 2. The system 300 includes a user device 302, a schedule and callback single page application (SPA) 303 (also referred to as a micro-frontend (MFE) 303), a first callback scheduler 304a and a second callback scheduler 304b (referred to collectively as “callback schedulers 304”), a service request API 306, a participants API 308, and an authorization API 310, a queue widget 312, and a plurality of queues 314. In the embodiment described with respect to FIG. 3, the system 300 (or the system 100) may be embedded or implemented in a cloud computing environment. In various embodiments, the components of the system 300 may include a plurality of APIs to facilitate or execute scheduling the user callbacks. For example, the URL generator 202, the user authenticator 204, the user information manager 206, the queue manager 220, and the callback manager 226 may be implemented as a plurality of APIs.

The SPA 303 may be used or configured to dynamically update the user interface displaying the callback scheduler on the user device 302. For example, when a user has selected the URL to schedule the callback, has entered data to schedule the callback, has selected a timeslot, etc., the SPA 303 may facilitate updating of the user interface in real time.

Each of the first and second callback schedulers 304a and 304b may be identical or substantially identical. In various embodiments, the system 300 may utilize one or both of the first and second callback schedulers 304a and 304b to schedule user callbacks. In some implementations, one of the first and second callback schedulers 304a and 304b operates in the system 300 at any given time to facilitate scheduling user callbacks and the other of the first and second callback schedulers 304a and 304b is used only in the event of a failure of the operating callback scheduler. For example, the first callback scheduler 304a may be used by the system 300 to schedule user callbacks for the entire provider system (e.g., for all users scheduling callbacks from the provider). The first callback scheduler 304a may malfunction or cease performance, and the system may switch to utilizing the second callback scheduler 304b to scheduler user callbacks. In other embodiments, both of the first and second callback schedulers 304a and 304b may be used at the same time to scheduler user callbacks. For example, the first callback scheduler 304a may be used to schedule callbacks for users located in one portion of the region reached by the provider and the second callback scheduler 304b may be used to schedule callbacks for users located in a remaining portion of the region.

The first and second callback schedulers 304a and 304b each include a schedule callback API gateway 316a and 316b, respectively (and referred to collectively as schedule callback API gateway 316), a URL builder function 318a and 318, respectively (and referred to collectively as the URL builder function 318), an authorizer function 320a and 320b, respectively (and referred to collectively as the authorizer function 320), a get/post function 322a and 322b, respectively (referred to collectively as the get/post function 322), and a health function 342 and 324b, respectively (referred to collectively as the health function 324).

In various implementations, the callback schedulers 304 may include multiple layers. The components of the callback schedulers may be located in different layers. For example, each callback scheduler 304 may include a public layer 326, a virtual private cloud (VPC) 328, and a private subnet 330. The components 318-324 may be located within the private subnet 330 (and, therefore the VPC 328). The API gateway 316 may be located within the public layer 326. The multiple layers may secure the system 300 such that unauthorized users are unable to access information within the system 300.

The API gateway 316 may allow communication and/or access between the user device 302 and the callback schedulers 304. For example, upon encryption/decryption of the parameters in the generated URL and validation of the user, the API gateway 316 may allow the user device to access the functions 318-324 to schedule the callback, such as via API calls. The system may first call the API gateway 316 to facilitate or permit access to the functions 318-324. The API gateway 316 may facilitate transmittal of information from the callback scheduler 304 to the SPA 303 and the user device 302.

The URL builder function 318 is configured to generate the URL. The URL builder may be similar to the URL generator 202. Specifically, the URL builder function 318 is configured to encrypt and decrypt the parameters of the URL associated with the user information of the user. For example, when generating the URL, the URL builder function 318 encrypts the URL and, upon the user selecting the URL, decrypts the URL to allow the user to access the callback scheduler and schedule the callback.

The authorizer function 320 is configured to authenticate the user/user device 302. The authorizer function 320 may be similar to the user authenticator 204. The authorizer function 320 may permit an unregistered user to schedule a callback using the system 300. For example, the authorizer function 320 may utilize the security token embedded in the generated URL to determine whether the user scheduling the callback is associated with the service request for which the callback is being scheduled.

When a user attempting to schedule a callback is an unregistered user, the authorizer function 320 (or another component of the system 300, a component external to the system 300 and associated with the provider, etc.) may validate the user. To validate the user, the authorizer function 320 may create a temporary user identification (e.g., a temporary username and/or password) to associate the unregistered user with the service request they are scheduling the callback for. This may allow the system 300 to retrieve service request information (e.g., from the service request information database 208) and/or user information (e.g., from the user information database 210), which allows the user to continue to schedule the callback.

The get/post function 322 is configured to generate the user interface to display to the user. For example, the get/post function 322 may generate the user interface where the user is able to input a service request identifier and personal information (e.g., a phone number) and view the plurality of timeslots. Responsive to the user selecting a timeslot and the system 200 (e.g., the get/post function 322) receiving an indication that the user has selected the timeslot, the get/post function 322 may generate the confirmation page confirming the scheduled callback to display to the user via the user interface.

The health function 324 is configured to monitor the health and activity of the callback scheduler. For example, the heath function 324 may perform a health or status check of the system 300 periodically (e.g., every 60 seconds, every 60 minutes, every 24 hours, etc.). Responsive to a determination that the system 300 is malfunctioning, the health function 324 may generate a notification of the malfunction. In some embodiments, a determination by the health function 324 that the system is malfunctioning may cause the system 200 to switch from utilizing the first callback scheduler 304a to utilizing the second callback scheduler 304b.

Referring still to FIG. 3, an exemplary computer-implemented workflow or process is described with respect to the components of the system 300.

At process 350, the URL builder function 318 generates a URL and transmits the URL to the user device 302 via the API gateway 316. The system 300 receives an indication that the user of the user device selects the URL. At process 351, the schedule callback SPA/MFE 303 transmits the indication to the API gateway 316. At process 352, the API gateway 316 transmits the indication of the selection to the authorizer function 320 to authenticate the user. Upon receipt of the indication of the selection, at process 353, the authorizer function 320 authorizes the user. Specifically, the authorizer function 320 makes an API call to the authorization API 310 to retrieve a security token to authenticate the user. Once the user is verified using the security token (e.g., if authentication is successful), the get/post function 322 makes additional API calls. For example, at process 354, the get/post function 322 makes a first API call to the service request API 306. Responsive to the request, the get/post function 322 receives the service request information (e.g., a service request identifier, a location associated with the service request, a line of business associated with the service request, etc.). For example, the authorizer function 320 may receive a service request identifier and a location of the service request. At process 356, the get/post function 322 may make a second API call to a participants API 308. Responsive to the request, the get/post function 322 may receive user information such as a name, phone number, type of user (e.g., registered or unregistered), etc. The get/post function 322 may also receive the security token generated by the authorizer function 320 that is used to authorize the user.

Using the information received from the APIs, the get/post function 322 may generate a user interface to display to the user. For example, the get/post function 322 may generate a user interface displaying the service request identifier that the user is scheduling a callback for as well as one or more contact methods for the user. At process 350, the get/post function 322 transmits the user interface to the user device 302 via the API gateway 316.

The user may input, via the user interface, a different contact method (e.g., a different phone number) to the user interface and/or select a contact method from the predetermined contact list generated by the get/post function 322 using the API information. The user may submit, via the user interface, the information. Responsive to receipt of the submission or an indication of the submission, at process 360, the get/post function 322 may make an API call to the queue widget 312. The queue widget 312 may determine, based on the service request information and user information, which queue of the plurality of queues 314 should be used to select an agent to handle the user callback. As shown in FIG. 3, the queues 314 may include a plurality of types of queues. For example, the queues 314 may include queues for individual states or location having particular requirements, queues of agents having a particular experience level, queues of agents having a particular area of expertise or qualification, etc. Upon selecting a queue (and, in some implementations, an agent associated with the queue to handle the callback), the get/post function may receive, from the queue widget 312, a plurality of timeslots associated with an agent of the selected queue from which the user can select to schedule the callback. The get/post function 322 may display the timeslots to the user via the user interface on the user device 302. The user may select a timeslot and the callback scheduler 304 may receive an indication of the selected timeslot.

At process 362, the health function 324 performs a health check of the system 300. The process 362 may be performed periodically and at one or more points during the processes 350-360.

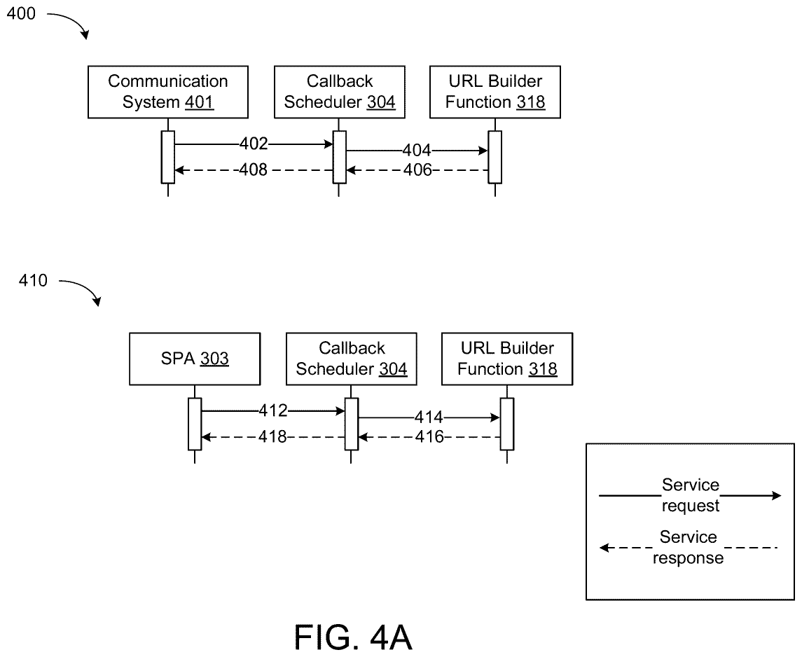

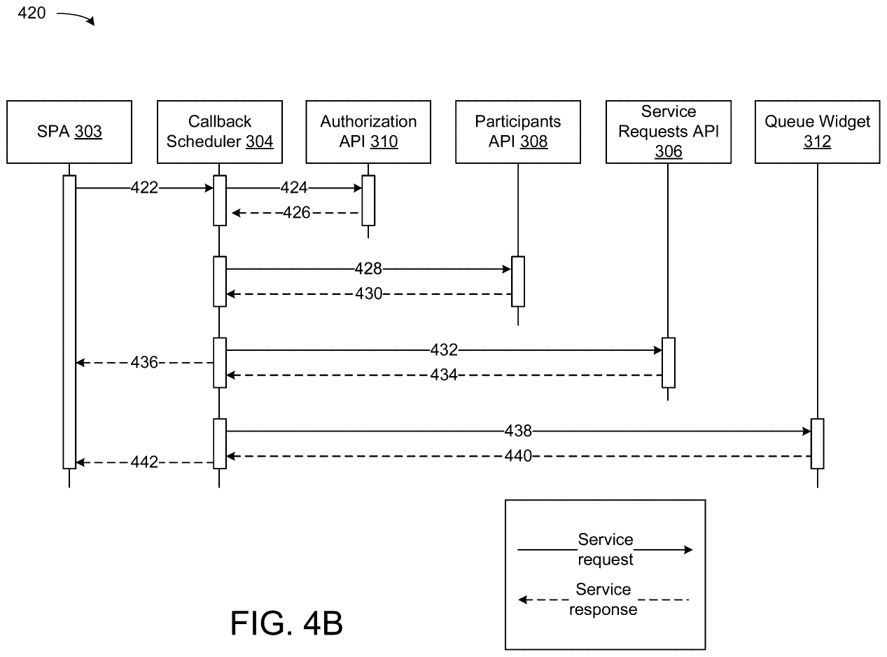

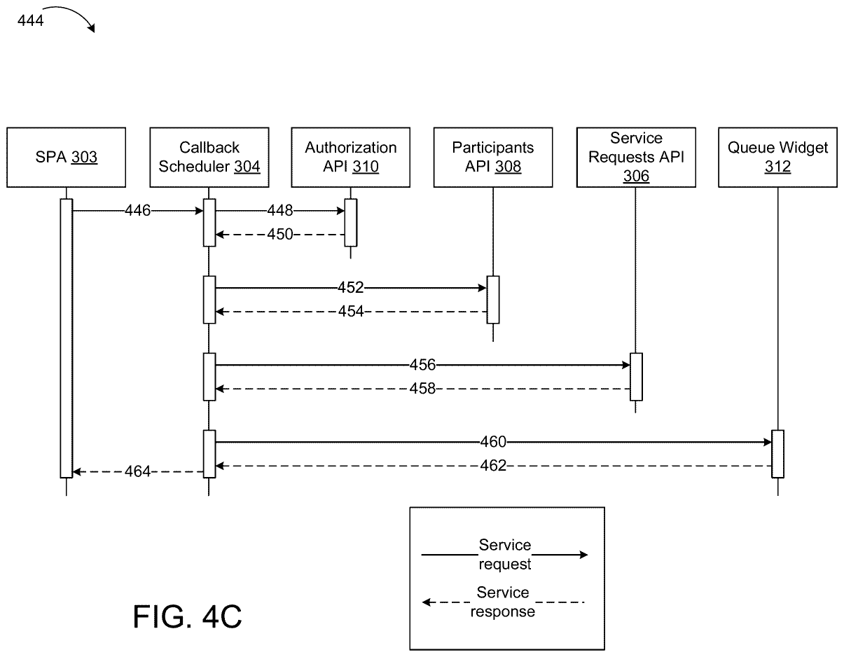

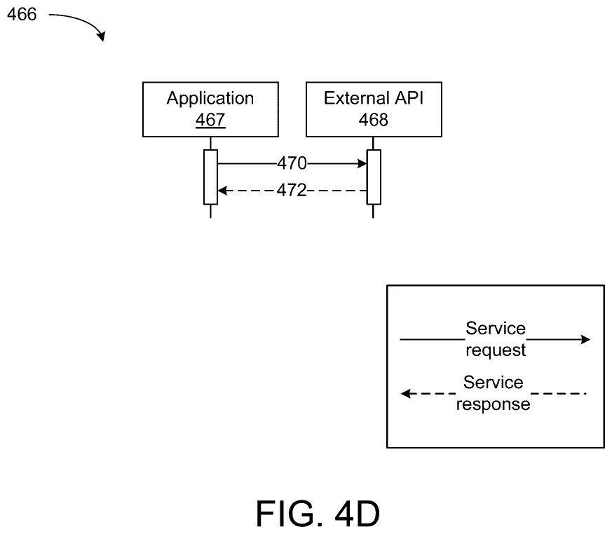

Referring now to FIGS. 4A-4D, flow diagrams are shown for various processes described with respect to FIG. 3. For example, the URL builder function 318 and the get/post function 322 are described in greater detail.

Referring to FIG. 4A, a flow diagram 400 for an encryption process and a flow diagram 410 for a decryption process are shown, according to an example embodiment. The processes for encryption and decryption may be the same or similar. In various implementations, encryption of the URL may occur before decryption of the URL. For example, the callback scheduler 304 may transmit an encrypted URL to the user device prior to authentication of the user and may decrypt the URL upon authentication of the user.

At process 402, the callback scheduler 304 receives a request from a communication system 401. During an encryption process, the communication system 401 may be a component or application associated with the provider. For example, the callback scheduler 304 may receive a request indicative of a request to schedule a callback. At process 404, the callback scheduler 304 makes a request (e.g., an API call) to the URL builder function 318. Specifically, the callback scheduler 304 may implement or otherwise provide a “get” function/endpoint (as will be described with respect to FIG. 4C). Upon receiving the request from the callback scheduler 304, the URL builder function 318 may generate the URL (e.g., in the manner described with respect to the URL generator 202 of FIG. 2 and/or the URL builder function 318 of FIG. 3). The URL builder function 318 may encrypt the URL to transmit to the user device using secret keys, public keys, private keys, passphrases, etc. At process 406, the callback scheduler 304 may receive the generated URL from the URL builder function 318 and, at process 408, the callback scheduler 304 may transmit the generated URL to the user device 302.

The processes 412-416 for decryption of the URL may be similar to the processes 402-408 described with respect to the encryption process. For example, after receipt of the encrypted URL by the user device 302, at process 412, the callback scheduler 304 may receive a request from the SPA 303. Specifically, during a decryption process, the user scheduling a callback may input information to the user interface and/or select the URL, and the SPA 303 may facilitate transmitting the information from the user device 302 to the callback scheduler 304. The request may include an indication that the user is to be authenticated to schedule the user callback. At process 414, the callback scheduler 304 performs the “get” function to request decryption of the URL by the URL builder function 318. For example, the URL builder function 318 may use the secret keys, public keys, private keys, passphrases, etc. to decrypt the URL. At process 416, the URL builder function 318 may transmit the decrypted URL to the callback scheduler 304. At process 418, the callback scheduler 304 may transmit the decrypted URL to the user device 302 to permit the user to schedule the callback using the various functions 320-324.

Referring to FIG. 4B, a flow diagram 420 for a “get” process is shown, according to an example embodiment. The flow diagram 420 may describe a method or process of getting or obtaining schedules of the plurality of queues to determine which timeslots are available to select, by a user, as a callback time.

At process 422, the callback scheduler 304 receives a request from the SPA 303. At process 424, the callback scheduler 304 initiates a request (e.g., an API call, etc.) to the authorization API 310 to authorize a user attempting to schedule the callback. The process 424 may ensure that the user has proper authorization to access the callback scheduler 304 to schedule a callback. The authorization API 310 may return, at process 426, a response to the callback scheduler 304 indicating that the user has been authenticated.

At process 428, the callback scheduler 304 initiates a request (e.g., an API call) to the participants API 308. In some embodiments, the callback scheduler 304 may transmit a security token with the request. The security token may indicate the authentication of the user to permit the participants API 308 to transmit personal information about the user to the callback scheduler 304. For example, process 428 may validate the call to the participants API 308 to get or retrieve user information of the user (e.g., the name of the user, contact information of the user, etc.). At process 430, the participants API 308 transmits the participant information to the callback scheduler 304. In some embodiments, the participants API 308 may retrieve the participant information from a first database that includes partially masked or disguised participant information (e.g., a partially masked user phone number) to provide additional security for the user when scheduling the callback.

At process 432, the callback scheduler 304 initiates a request (e.g., an API call) to the service requests API 306. In some embodiments, the callback scheduler 304 may transmit a security token with the request. The security token may indicate the authentication of the user to permit the service requests API 306 to transmit information about the service request (e.g., a service request identifier, a location of the service request, etc.) associated with the user to the callback scheduler 304. At process 434, the participants API 308 transmits the participant information to the callback scheduler 304. At process 436, the callback scheduler 304 transmits the information received at process 430 to the SPA 303. For example, the callback scheduler 304 transmits user information (e.g., user's name, user contact information, service request information, etc.) to the SPA 303.

At process 438, the callback scheduler 304 initiates a request to the queue widget 312. In some embodiments, the callback scheduler 304 may transmit an indication (e.g., a certification) that the user has been authorized to access the queues via the queue widget 312. At process 440, the queue widget 312 transmits a selected queue and additional information (e.g., the plurality of timeslots associated with the queue) to the callback scheduler 304. At process 442, the plurality of timeslots are transmitted from the callback scheduler 304 to the SPA 303 for transmittal to and display on the user device 302 to facilitate the user scheduling the callback.

Referring to FIG. 4C, a flow diagram 444 for a post process is shown, according to an example embodiment. The post process may be or include a process or method for facilitating scheduling the customer callback (e.g., as opposed to the flow diagram 420 that discusses obtaining schedules to schedule the callback).

At process 446, the callback scheduler 304 receives a request from the SPA 303. At process 448, the callback scheduler 304 initiates a request (e.g., an API call, etc.) to the authorization API 310 to authorize a user attempting to schedule the callback. In some implementations, the request initiated at process 448 may be a call for the “post” function/endpoint. The authorization API 310 may return, at process 450, a response to the callback scheduler 304 indicating that the user has been authenticated.

At process 452, the callback scheduler 304 initiates a request (e.g., an API call) to the participants API 308. In some embodiments, the callback scheduler 304 may transmit a security token with the request. The security token may indicate the authentication of the user to permit the participants API 308 to transmit personal information about the user to the callback scheduler 304. For example, process 452 may validate the call to the participants API 308 to get or retrieve user information of the user (e.g., the name of the user, contact information of the user, etc.). At process 454, the participants API 308 transmits the participant information to the callback scheduler 304.

At process 456, the callback scheduler 304 initiates a request (e.g., an API call) to the service requests API 306. In some embodiments, the callback scheduler 304 may transmit a security token with the request. The security token may indicate the authentication of the user to permit the service requests API 306 to transmit information about the service request (e.g., a service request identifier, a location of the service request, etc.) associated with the user to the callback scheduler 304. At process 458, the participants API 308 transmits the participant information to the callback scheduler 304. In some embodiments, the participants API 308 may retrieve the participant information from a second database (different than the first database used in processes 432 and 434 of FIG. 4B) that includes unhidden or unmasked participant information (e.g., a full phone number of the user).

At process 460, the callback scheduler 304 initiates a request to the queue widget 312. In some embodiments, the callback scheduler 304 may transmit an indication (e.g., a certification) that the user has been authorized to access the queues via the queue widget 312. At process 462, the queue widget 312 transmits a selected queue and additional information (e.g., the plurality of timeslots associated with the queue) to the callback scheduler 304. At process 464, the selected queue and the plurality of timeslots are transmitted from the callback scheduler 304 to the SPA 303 for transmittal to the user device 302 to schedule the callback.

Referring to FIG. 4D, a flow diagram for a process 466 of token generation is shown, according to an example embodiment. The process 466 may be performed by any application 467 associated with a provider. For example, token generation may be performed when an application 467 (a user or entity associated with the provider, a user or entity not associated with the provider, or any other user attempting to schedule a callback) and an external API 468 for use in authenticating the user. In various embodiments, the external API 468 may be associated with the provider. For example, in the example described with respect to FIG. 4D, the external API 468 may be a service request authorization API. The application 467 and the service request authorization API may both be associated with the same provider but associated with, for example, separate entities of the provider.

At process 470, the application 467 may initiate a request (e.g., an API call) to the service request authorization API 468. The service request authorization API 458 may generate a security token and transmit the token to the application 467. At process 472, the service request authorization API 458 may transmit external information (e.g., an external service request identifier, an external user identifier, etc.). to the application 467. The generated token may be used in authenticating the user in processes described above with respect to FIGS. 4A-4C.

Referring now to FIG. 5, a flow diagram of an exemplary computer-implemented or computer-based process or method 500 of scheduling a callback with a provider is shown, according to some embodiments. As shown, the method 500 includes a first method 502 for generating a URL and a second method 518 for scheduling a user callback.

It should be understood that the method 502 may be performed in isolation from additional steps of the method 500 and/or the method 518. For example, the method 502 may be performed to generate any user-specific, customized URL. That is, the method 502 may be performed in instances beyond generating a custom URL to schedule a user callback.

Further, it should be understood that the method 518 may be performed in isolation from additional steps of the method 500 and/or the method 502. That is, the method 518 may be performed in instances where a user-specific URL is not generated or utilized to schedule a customer callback.

As stated, the method 500 includes a sub-method 502 for generating a user-specific URL. In various embodiments, the method 502 may be implemented specifically for generating a user-specific URL to schedule a callback. At process 504, the URL generator 202 generates a URL to schedule a callback. The URL may be unique to the user and the callback to be scheduled. (e.g., one URL may be used by a single user and causes a user interface to include information unique to the user for whom the URL is generated). In some implementations, the URL may allow the user to schedule the callback independent of a registration of the user within a system associated with the provider. As such, in certain embodiments, the user may not be a user registered with the system associated with the provider.

At process 506, the URL generator 202 extracts one or more parameters from the URL. The one or more parameters may be associated with an identifier of the user associated with the URL. For example, the one or more parameters may include identifying information of the user (e.g., name, birthdate, etc.). The one or more parameters being included in the URL may permit an unregistered user to schedule a callback without inputting user credentials to access a user account associated with the provider.

At process 508, the URL generator 202 generates, using the extracted parameters, a security token. The security token may permit the user to schedule the callback. That is, the security token may permit the user to proceed with entering information to a generated user interface for scheduling the callback. Further, the security token may permit the user to access one or more components (e.g., the callback scheduler 110, the agent handling system 120, one or more APIs to facilitate execution of components of the callback scheduler 110 or the agent handling system 120, etc.).

At process 510, the URL generator 202 embeds the security token within the URL. The security token being embedded within the URL may permit an unregistered user to schedule a callback without inputting user credentials to access a user account associated with the provider.

At process 512, the URL generator 202 hashes the URL to hide the one or more parameters and the security token within the URL. Hashing the URL to hide the one or more parameters and the security token may secure the URL and prevent unauthorized users from accessing private user data. In some embodiments, the URL generator 202 may access, using, for example, public key cryptology, a data field. The data field may include the identifier of the user associated with the URL that is associated with the hashed parameters. Accessing the data field may permit the callback scheduling system 100 to identify, retrieve, access, etc. identifying user information.

At process 514, the URL generator 202 provides the URL with the embedded security token and the hashed parameters to a user device. The URL may be hyperlinked in a message or notification (e.g., a text message, an email, etc.) to the user via the user device. Upon selecting the URL, the callback scheduling system 100 may cause a user interface to be displayed on a user interface (e.g., the user interface 144 or 154) of the user device (e.g., the user device 140 or 150).

In some implementations, the method 500 further includes the user authenticator 204 validating an authentication of the user. The user authenticator 204 may validate the user using the security token embedded in the URL and permit the user to schedule the callback.

At process 516, the callback scheduler 110 (e.g., the user information manager 206) receives information relating to a service request associated with the callback to be scheduled. The user information manager 206 may receive the information from the service request information database 208 responsive to the URL being provided to the user device. In some implementations, the user information manager 206 may receive the information from the service request information database 208 responsive to receiving an input of a service request identifier by the user to the user interface. The information relating to the service request may include a location of at least one of: the user or an event associated with the service request.

Method 518 may begin with process 520. At process 520, the agent handling system 120 may receive a selection or an indication of a selection of the URL from the user device. In various embodiments, the agent handling system 120 may receive the selection or indication of the selection from the user device or the callback scheduler 110.

At process 522, the queue manager 220 may determine, from a plurality of queues, a queue from which to retrieve a plurality of timeslots to schedule the callback. The queue may be determined based on the information from the service request received at process 516. In various embodiments, the queue manager 220 may receive the information relating to the service request from the callback scheduler 110.

In various embodiments, each queue of the plurality of queues may be associated with a plurality of agents of the provider that are designated to respond to one or more types of service requests. For example, the information relating to the service request may indicate one or more queues of the plurality of queues that are eligible to be associated with the service request. For example, the information relating to the service request may indicate that no specific location requirements, licensing requirements, etc. exist and any agent can handle the service request. The queue manager 220 may select any queue from the plurality of queues from which to retrieve the plurality of timeslots.

In other embodiments, the information relating to the service request may indicate that the service request is to be handled by an agent in a certain location and/or an agent having certain capabilities. The queue manager 220 may select one or more specific queues from the plurality of queues that are eligible or able (e.g., have associated agent with the appropriate location and/or qualifications) to handle the service request.

At process 524, the queue manager 220 may determine a characteristic of the service request using the information relating to the service request. For example, the queue manager 220 may determine a state in which an event relating to the service request occurred. The characteristic may indicate a queue or type of agent capable or designated to respond to the service request.

At process 526, the queue manager 220 may determine the first queue from among the plurality of queues by determining the first queue is associated with agents designated to respond to the service request based on the characteristic of the service request. For example, when the characteristic determined at process 524 indicates state in which an event relating to the service request occurred, the queue manager 220 may determine that a first queue is associated with agents licensed in and/or located in the state in which the event request occurred and are therefore capable of responding to the service request. The queue manager 220 may select the queue and/or an agent of the queue to address or respond to the service request.

In some implementations, each queue of the plurality of queues is associated with a different jurisdiction. Each jurisdiction may include associated requirements for the plurality of agents associated with the queue (e.g., a specific license or type of license). In some embodiments, each queue of the plurality of queues is associated with one or more different capabilities. Each agent of the plurality of agents associated with each queue is designated as possessing the capabilities. For example, each agent in a certain queue may be designated as being capable of handling service requests related to a particular type of event. In certain implementations, each queue of the plurality of queues is associated with at least one of: a level of experience of each agent or a designated role of each agent.

At process 528, the callback manager 226 may retrieve the plurality of timeslots from the determined queue. The plurality of timeslots may be associated with an agent of the plurality of agents. Specifically, the plurality of timeslots may be associated with an agent assigned to handle the callback. At process 530, the callback manager 226 may transmit the plurality of timeslots to the user device. The plurality of timeslots may be displayed to the user via the user interface of the user device. In some embodiments, at process 530, the callback manager 226 may cause the user device to present, to the user, based on the received plurality of timeslots and an availability of the user, a subset of the plurality of timeslots. At process 532, the callback manager 226 may receive a selection of a timeslot from the user device. At process 534, the callback manager 226 may schedule the callback at the selected timeslot. In some implementations, the callback manager 226 may transmit a phone number of the user to the agent to initiate the callback at the selected timeslot.

### Example User Interfaces

Referring now to FIG. 6, an exemplary user interface 600 for scheduling a callback is shown, according to some embodiments. The user interface 600 may be displayed to the user via a user interface (e.g., the user interface 144 or 154) of the user device. The user interface 600 may include a service request identifier 610 and the identifier 620 of the user. Further, the user interface 600 may include one or more contact methods 630. In some embodiments, the identifier 620 and the contact methods 630 may include one or more prepopulated values (e.g., prepopulated names and/or phone numbers). For example, as shown in FIG. 6, the user interface 600 includes the prepopulated name “Patricia” and two prepopulated phone numbers. Prepopulated information may be displayed on the user interface when the information is stored by the system. For example, the user information manager 206 may retrieve, from the user information database 210, a name of the user scheduling the callback and one or more phone numbers associated with the user. This information may be transmitted to the URL generator 202 or other component generating the user interface 600.

As shown, the user interface 600 may include an option for the user to input a new contact method (e.g., a new phone number) that was not previously stored by the system (e.g., the system 100, the system 300, etc.). Further, as shown in FIG. 6, the prepopulated contact methods may be partially hidden or disguised to protect private data of the user. Upon selecting a contact method to be used, the user interface 600 may indicate the selected method by, for example, filling in a bubble associated with the selected contact method.

The user interface 600 may include date preferences 640. For example, the user interface 600 include an option for the user to select a preferred date from two options. In various embodiments, the options may be generated by the user information manager 206 based on the service request information. For example, the user information manager 206 may receive service request information from the database 208 indicating an urgency of the service request to be addressed. Based on the level of urgency, the date preferences may change. For example, for an urgent service request, the user information manager 206 may generate date preferences that are 24 and 48 hours from the current date. In some embodiments, the user information manager 206 may generate standard date preferences (e.g., when the service request is not urgent). The standard date preferences may be a certain amount of time from the current date (e.g., one week).

The user interface 600 further includes a schedule button 650 that the user can select the retrieve a plurality of callback times. Responsive to the user selecting the button 650, the queue manager 220 may determine a queue from a plurality of queues that the plurality of timeslots should be selected from.

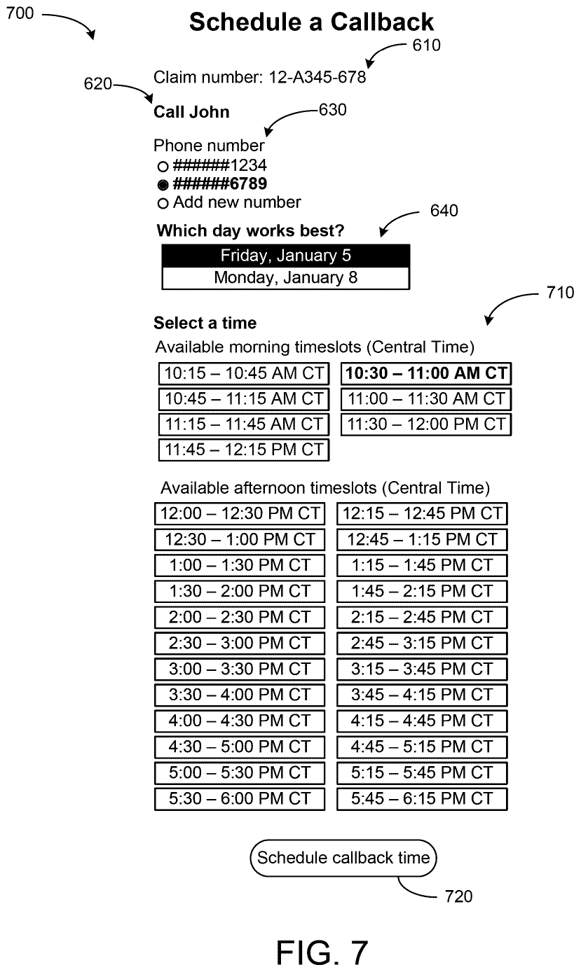

Referring now to FIG. 7, an exemplary user interface 700 for scheduling a callback is shown, according to some embodiments. The user interface 700 may be displayed responsive to the queue manager 220 determining a queue and the callback manager 226 retrieving the plurality of timeslots from the timeslot database 224. The user interface 700 may include elements from the user interface 600 including the service request identifier 610, the user identifier 620, contact methods 630, and the date preferences 640.

The user interface 700 may further include a plurality of timeslots 710. The plurality of timeslots 710 may be times available during the user-selected preferred date 640. The plurality of timeslots may be sorted in chronological order. In various implementations, the user interface may group subsets of the plurality of timeslots based on time of day (e.g., morning, afternoon, and evening). The user interface 700 may further include a button 720 for confirming the selected timeslot from the plurality of timeslots and scheduling the callback for the selected timeslot.

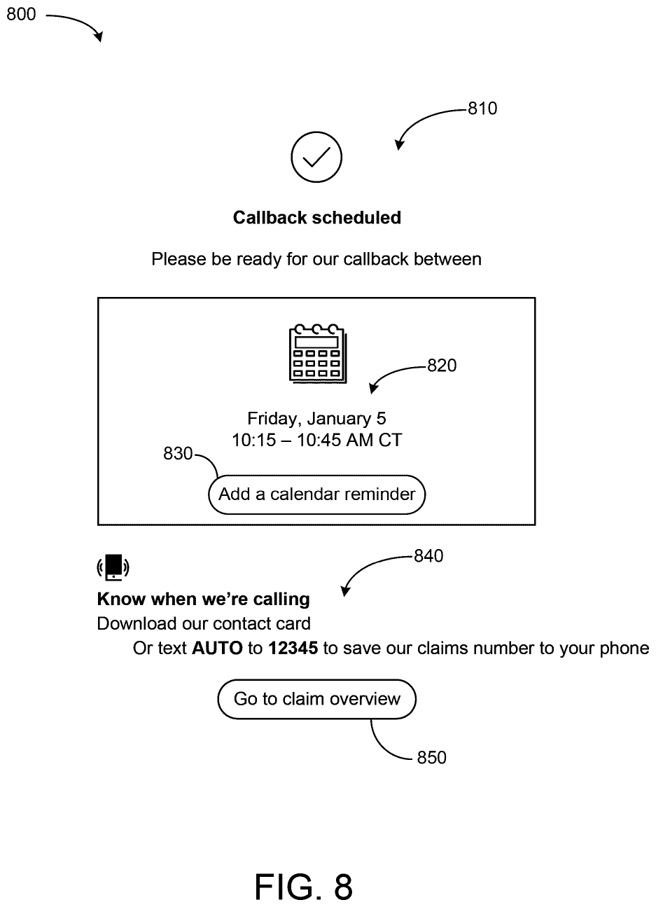

Referring now to FIG. 8, an exemplary user interface 800 for confirming a scheduled callback is shown, according to some embodiments. Upon selecting the button 720 on the user interface 700, the user interface 800 may be displayed. As shown, the user interface 800 may include a confirmation indicator 810 indicating that the callback has been scheduled. The user interface 800 may further include an icon 820 indicating the scheduled date and time, as well as an “add to calendar” icon 830. Upon selecting the icon 830, an additional user interface may be displayed that allows the user to add the callback as an appointment, reminder, event, etc. to a calendar application of the user device.

The user interface 800 may further include a selectable contact card icon 840. Upon selecting the icon 840, the user may be able to save the phone number from which the callback will be received. This may aid the user in identifying the number upon receipt of the scheduled callback. The contact card icon 840 may additionally or alternatively include an indication for the user to message a phone number to receive a text message or other notification that includes the phone number from which the callback will be received. The user interface 800 may further include a service request button 850. Upon selecting the button 850, an additional user interface may be displayed that includes information relating to the service request associated with the scheduled callback.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In various implementations, a computer program is provided, and the program is embodied on a computer readable medium. In various embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In various implementations, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For instance, the position of elements may be reversed or otherwise varied, and the nature or number of discrete elements or positions may be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions may be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations may be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations may be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

1. A system for scheduling a callback comprising:
one or more non-transitory computer readable media storing instructions thereon that, when executed by one or more processors, cause the one or more processors to:
generate a URL to schedule the callback, the URL unique to a user and the callback and allowing the user to schedule the callback independent of a registration of the user with the system, generating the URL comprising:
generating a security token to permit the user to schedule the callback; and
embedding the security token within the URL;
provide the URL with the embedded security token to a user device;
receive information relating to a service request associated with the callback to be scheduled;
receive a selection of the URL from the user device;
determine, from a plurality of queues, a first queue from which to retrieve a plurality of timeslots to schedule the callback based on the information relating to the service request by:
determining a characteristic of the service request using the information; and
determining the first queue from among the plurality of queues by determining the first queue is associated with agents designated to respond to the service request based on the characteristic of the service request;
retrieve the plurality of timeslots from the determined queue, the plurality of timeslots associated with an agent of the plurality of agents associated with the determined queue;
transmit, to the user device, the plurality of timeslots;
receive, from the user device, a selection of a timeslot; and
schedule the callback at the selected timeslot.

2. The system of claim 1, wherein the instructions further cause the one or more processors to:
present, to the user via the user device, based on the received plurality of timeslots and an availability of the user, a subset of the plurality of timeslots.

3. The system of claim 1, wherein the information relating to the service request includes a location of at least one of the user or an event associated with the service request.

4. The system of claim 1, wherein generating the security token comprises: extracting one or more parameters from the URL, the one or more parameters associated with an identifier of the user associated with the URL, and wherein the security token is generated using the one or more extracted parameters.

5. The system of claim 4, generating the URL further comprising: hashing the URL to hide the one or more parameters and the security token within the URL.

6. The system of claim 5, wherein the instructions further cause the one or more processors to access, using public key cryptology, a data field, the data field comprising the identifier of the user associated with the URL.

7. The system of claim 1, wherein the instructions further cause the one or more processors to transmit a phone number of the user to the agent to initiate the callback at the selected timeslot.

8. The system of claim 1, wherein the instructions further cause the one or more processors to: validate an authentication of the user using the security token embedded in the URL.

9. The system of claim 8, wherein validating an authentication of the user using the security token is performed prior to providing the user with options for timeslots, and wherein retrieving the plurality of timeslots from the determined queue is performed responsive to authenticating the user.

10. The system of claim 1, wherein each queue of the plurality of queues is associated with a different jurisdiction, wherein each jurisdiction has associated requirements for the plurality of agents associated with the queue.

11. The system of claim 1, wherein each queue of the plurality of queues is associated with one or more different capabilities, wherein each agent of the plurality of agents associated with each queue is designated as possessing the capabilities.

12. The system of claim 1, wherein each queue of the plurality of queues is associated with at least one of: a level of experience or a designated role.

13. A method for scheduling a callback, the method comprising:
generating, by one or more processors, a URL to schedule the callback by:
generating, by the one or more processors. a security token to permit a user to schedule the callback; and
embedding, by the one or more processors, the security token within the URL;
providing, by the one or more processors, the URL with the embedded security token to a user device;
receiving, by the one or more processors, information relating to a service request associated with the callback to be scheduled;
receiving, by the one or more processors, a selection of the URL from the user device;
determining, by the one or more processors, from a plurality of queues, a first queue from which to retrieve a plurality of timeslots to schedule the callback based on information relating to a service request associated with the callback by:
determining a characteristic of the service request using the information; and
determining the first queue from among the plurality of queues by determining the first queue is associated with agents designated to respond to the service request based on the characteristic of the service request;
retrieving, by the one or more processors, the plurality of timeslots from the determined queue, the plurality of timeslots associated with an agent of the plurality of agents associated with the determined queue;
transmitting, by the one or more processors, to the user device, the plurality of timeslots;
receiving, by the one or more processors, from the user device, a selection of a timeslot; and
scheduling, by the one or more processors, the callback at the selected timeslot.

14. The method of claim 13, wherein the URL is unique to the user and the callback to be scheduled.

15. The method of claim 13, wherein the URL allows the user to schedule the callback independent of a registration status of the user.

16. The method of claim 13, further comprising accessing, using public key cryptology, a data field, the data field comprising an identifier of the user associated with the URL.

17. One or more non-transitory computer readable storage media storing instructions for scheduling a callback thereon that, when executed by one or more processors, cause the one or more processors to perform operations comprising:
generating a URL to schedule the callback, the URL unique to a user and the callback and allowing the user to schedule the callback independent of a registration of the user with a system executing the callback, generating the URL comprising:
generating a security token to permit the user to schedule the callback; and
embedding the security token within the URL;
providing the URL with the embedded security token to a user device;
receiving information relating to a service request associated with the callback to be scheduled;
receiving, from a user device, a selection of a URL to schedule the callback,
determining, from a plurality of queues, a first queue from which to retrieve a plurality of timeslots to schedule the callback based on information relating to a service request associated with the callback to be schedule by:
determining a characteristic of the service request using the information; and
determining the first queue from among the plurality of queues by determining the first queue is associated with agents designated to respond to the service request based on the characteristic of the service request;
retrieving the plurality of timeslots from the determined queue, the plurality of timeslots associated with an agent of the plurality of agents associated with the determined queue;
transmitting, to the user device, the plurality of timeslots;
receiving, from the user device, a selection of a timeslot; and
scheduling the callback at the selected timeslot.

18. The non-transitory computer readable storage media of claim 17, wherein each queue of the plurality of queues is associated with a different jurisdiction, wherein each jurisdiction has associated requirements for the plurality of agents associated with the queue.

19. The non-transitory computer readable storage media of claim 17, wherein each queue of the plurality of queues is associated with one or more different capabilities, wherein each agent of the plurality of agents associated with each queue is designated as possessing the capabilities.

20. The non-transitory computer readable storage media of claim 17, wherein each queue of the plurality of queues is associated with at least one of: a level of experience or a designated role.
